(19) United States
(12) Patent Application Publication
(10) Pub. No.: US 2026/0115565 A1
(43) Pub. Date: Apr. 30, 2026

(54) GOLF PRACTICE DEVICE

(71) Applicant: SGLAB INC., Ansan-si (KR)

(72) Inventors: Eddie CHO, Seoul (KR); Taeeun KIM, Seogwipo-si (KR); Jichang HWANG, Seoul (KR)

(73) Assignee: SGLAB INC., Ansan-si (KR)

(21) Appl. No.: 19/167,926

(22) PCT Filed: Oct. 28, 2024
(86) PCT No.: PCT/KR2024/016495

§ 371 Date: Sep. 23, 2025

(30) Foreign Application Priority Data
Oct. 25, 2024 (KR) 10-2024-0147655

(51) Int. Cl. A63B 69/36; A63B 60/46

(52) U.S. Cl. CPC A63B 69/3632; A63B 60/46; A63B 2060/464; A63B 2225/50

(57) ABSTRACT

A golf practice device of the present invention that includes a shaft, a head portion provided at one side of the shaft, and a grip portion provided to surround an outer portion of the shaft at the other side of the shaft may include: a data processing module disposed in the shaft to process data; and a capsule structure having an inner space in which the data processing module is mounted and allowing the data processing module to be placed inside the shaft.

### TECHNICAL FIELD

The present invention relates to a golf practice device, and more particularly, to a golf practice device capable of measuring a pressure with which a golfer, who is a user, holds a grip of a golf club, thereby assisting in golf practice.

### BACKGROUND ART

Golf is a sport in which a golf ball is hit into holes on a golf course. Accordingly, a golfer should hit a golf ball by swinging a golf club to hit the golf ball into holes, and a lot of practice is necessary for the golfer to play with a small number of strokes.

Meanwhile, holding a grip of a golf club with both hands is the start of a swing. In particular, an appropriate grip strength is a prerequisite for a smooth swing, and if the grip is held too tight, the whole body may stiffen and cause a mishit. However, many golfers unintentionally hold the grip too tight. In reality, it has been found out that there is a huge difference in a grip holding strength, that is, grip strength, between professional golfers and amateur golfers.

Accordingly, golf trainers advise golfers to always “relax the grip and hit” in order to achieve a consistent golf swing. However, it is difficult for golf beginners to relax the grip and hit during a golf swing.

Golf Magazine, an American golf magazine, has released a computer analysis of a change in grip strength during a swing of professional golfers and amateur golfers. As a result, experimental results showed that amateur golfers hold the grip with twice as much strength than professional golfers.

An appropriate grip strength is one reason for a smooth swing of professional golfers. First, grip strength at the time of address was found to be similar between professional golfers (20%) and amateur golfers (26%). However, study results showed that, upon the start of a backswing, while the grip strength of the professional golfers insignificantly increased to 29%, the grip strength of the amateur golfers significantly increased to 52%.

Even at the top of the backswing, while the grip strength of the professional golfers increased by about two times that at the time of address to 48%, the grip strength of the amateur golfers drastically increased to 78%, which was three times that at the time of address. This is due to lifting a golf club only with arms while the torso is not sufficiently rotated. This is being pointed out as a cause of an outside-in swing trajectory that leads to a slice or a hook. At impact, the grip strength of the professional golfers was 85%, the grip strength of the amateur golfers was 97%, and there was no great difference between them. However, at a follow through around the waist after impact, while the grip strength of the professional golfers was 25%, the grip strength of the amateur golfers was 55%, which was two times or more than that of the professional golfers. That is, while the professional players increase the grip strength only at necessary moments, the grip strength of the amateur players is always high. In particular, an angle formed between the left arm and the shaft of a club upon the start of a downswing from the top of the backswing was 104° in the professional players but only 75° in the amateur players. This is one reason why strokes of professional players are longer. The angle of the professional players can accelerate a club head speed until impact.

A method recommended by trainers to prevent stiffening of the body due to strong grip is to practice light grip in which the left hand holds the grip as per usual and the right hand is put next to the left hand. Development of golf tools for such a practicing method is necessary, and such golf tools may be good for correcting existing swing habits of amateur golfers.

Accordingly, there is a need for development of a golf practice device that can measure and digitize a grip pressure of a golfer.

The inventor of the present invention has conducted research for a long period of time to meet the demand for development of the golf practice device and has completed the present invention after trial and error.

### DISCLOSURE

### Technical Problem

The present invention has been devised to address the problems of the related art, and one objective of the present invention is to provide a golf practice device capable of measuring a pressure with which a golfer holds a grip of a golf club, thereby assisting in golf practice.

Meanwhile, other unmentioned objectives of the present invention will be additionally taken into consideration within the scope easily inferable from the following detailed description and advantageous effects thereof.

### Technical Solution

One aspect of the present invention provides a golf practice device including a shaft, a head portion provided at one side of the shaft, and a grip portion provided to surround an outer portion of the shaft at the other side of the shaft, the golf practice device including: a data processing module disposed in the shaft to process data; and a capsule structure having an inner space in which the data processing module is mounted and allowing the data processing module to be placed inside the shaft.

In one embodiment of the present invention, the data processing module may collect at least one of swing data obtained by sensing a swing of a golfer and pressure data obtained by sensing a pressure generated by hands of the golfer.

In one embodiment of the present invention, the capsule structure may allow the data processing module to be placed at a position that overlaps the grip portion.

In one embodiment of the present invention, the capsule structure may be formed to be longer than at least a length of the data processing module and shorter than a length of the grip portion to be disposed to overlap the grip portion.

In one embodiment of the present invention, the capsule structure may have at least a portion spaced from an inner circumference of the shaft.

In one embodiment of the present invention, the golf practice device may further include a first fixing member and a second fixing member disposed on either sides of the capsule structure, and the first fixing member and the second fixing member may fix the capsule structure to an inner portion of the shaft and cause at least an area of the capsule structure that is between the first fixing member and the second fixing member to be spaced from the inner circumference of the shaft.

In one embodiment of the present invention, at least one of the first fixing member and the second fixing member may be made of an elastic material.

in one embodiment of the present invention, the capsule structure may include a body portion on which the data processing module is mounted and a flange portion provided at one side of the body portion, the flange portion may be exposed to the outside of the other side of the shaft, and a power terminal that receives power from the outside may be provided at the flange portion.

In one embodiment of the present invention, the capsule structure may include a body portion on which the data processing module is mounted and a flange portion provided at one side of the body portion, and an electrical terminal that receives power from the outside may be provided at the flange portion.

In one embodiment of the present invention, the flange portion may be exposed to the outside of the other side of the shaft.

In one embodiment of the present invention, the flange portion may have an outer diameter that is substantially the same as an outer diameter of the other side of the shaft.

In one embodiment of the present invention, the body portion may include a first body having the inner space in which the data processing module is mounted and a second body coupled to the first body to cover the inner space.

In one embodiment of the present invention, the grip portion may include a weight offset mechanism that reduces a weight of the grip portion to offset a weight increased due to the capsule structure and the data processing module.

In one embodiment of the present invention, the grip portion may have a recessed portion provided in a surface facing the shaft, and the recessed portion may reduce the weight of the grip portion and may offset the weight increased due to the capsule structure and the data processing module.

In one embodiment of the present invention, the golf practice device may further include a power storage device storing power supplied to the data processing module, and the power storage device may be disposed to overlap the grip portion.

In one embodiment of the present invention, the golf practice device may further include a data collection module including at least one of a pressure data collection module collecting the pressure data and a swing data collection module generating the swing data by sensing the swing of the golfer, the pressure data collection module may include a decompression film provided between the shaft and the grip portion and a circuit board electrically connected to the data processing module, and the pressure data collection module may detect a pressure generated on the grip portion to generate the pressure data and may transmit the pressure data to the data processing module.

In one embodiment of the present invention, the data processing module may process the data and generate training data, and a communication portion provided at the data processing module may transmit the training data to an external device through wireless communication.

In one embodiment of the present invention, a communication portion provided at the data processing module may transmit the data to an external device, and the external device may process the data and generate training data.

### Advantageous Effects

A golf practice device according to the present invention can measure a pressure with which a golfer holds a grip of a golf club and derive pressure data, thereby assisting in golf practice. In addition, the golf practice device can sense a swing trajectory and derive swing data. Accordingly, the golf practice device according to the present invention can correct a swing and a grip pressure of a golfer and induce an improvement in the golfer's golfing ability.

### DESCRIPTION OF DRAWINGS

FIG. 1 is a view for describing a golf practice device according to one embodiment of the present invention.

FIG. 2 is a partially-cut perspective view for describing an area that overlaps a grip portion illustrated in FIG. 1.

FIG. 3 is a cross-sectional view for describing the area overlapping the grip portion that is illustrated in FIG. 2.

FIG. 4 is a view for describing a pressure data collection module illustrated in FIG. 2.

FIG. 5 is a perspective view for describing a capsule structure and fixing members illustrated in FIG. 2.

FIG. 6 is an exploded perspective view for describing the capsule structure and the fixing members illustrated in FIG. 5.

FIG. 7 is a cross-section of the capsule structure illustrated in FIG. 5.

FIG. 8 is a plan view for describing a flange portion of the capsule structure.

FIG. 9 is a view for describing the relationship of a data processing module, a data collection module, and an external device.

FIG. 10 is a view for describing the data collection module illustrated in FIG. 9.

Note that the accompanying drawings are only exemplary and are provided as reference for understanding of the technical spirit of the present invention, and the scope of the present invention is not limited by the accompanying drawings.

### MODES OF THE INVENTION

General terms that are currently widely used have been selected as terms used in the present invention, but some terms may have been arbitrarily selected by the applicant in certain cases, and in such cases, the meanings of the terms should be understood in consideration of meanings described or used in details for carrying out the invention, instead of being simply defined based on the names of the terms.

Terms used in the present application are used to describe specific embodiments and are not intended to limit the present invention. A singular expression includes a plural expression unless the context clearly indicates otherwise. In the application, terms such as “include” or “have” should be understood as specifying that features, numbers, steps, operations, components, parts, or combinations thereof are present and not as precluding the possibility of the presence or addition of one or more other features, numbers, steps, operations, components, parts, or combinations thereof in advance.

The objectives, specific advantages, and novel features of the present invention should become more apparent from the following detailed description and exemplary embodiments. In addition, in describing the present invention, when detailed description of a related known art is determined as having the possibility of unnecessarily obscuring the gist of the present invention, the detailed description thereof will be omitted.

In addition, terms including ordinals such as “first” and “second” may be used to describe various components, but the components are not limited by the terms. The terms are only used for the purpose of distinguishing one component from another component.

A golf practice device according to one embodiment of the present invention will be described with reference to the accompanying drawings.

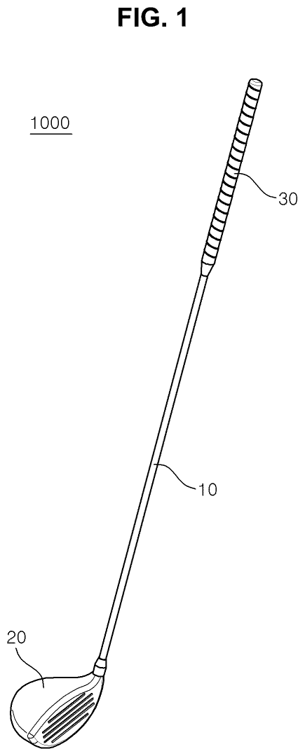

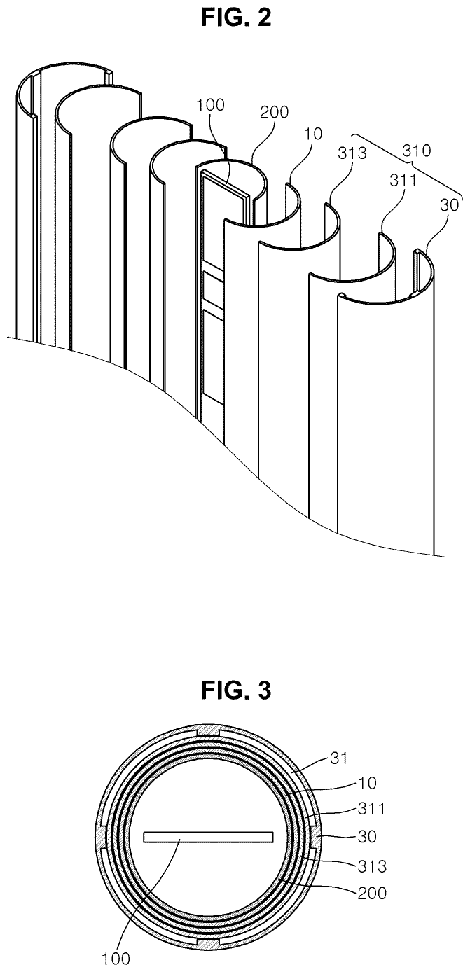

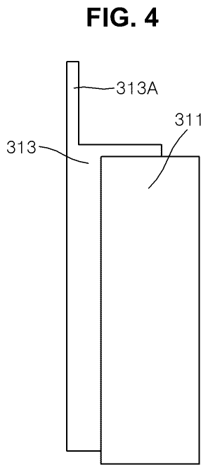

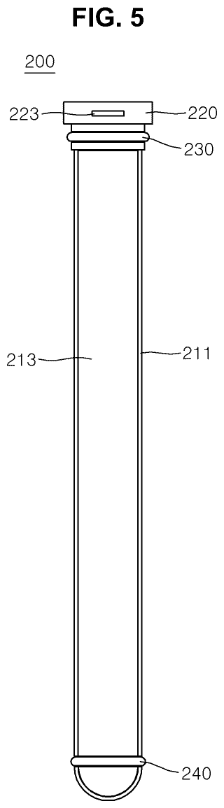

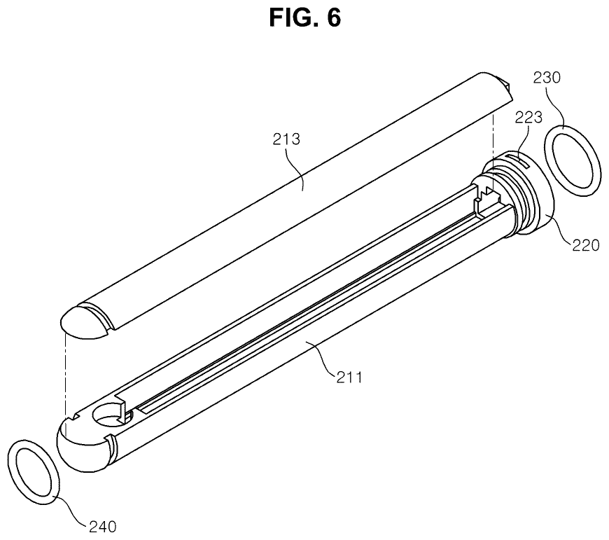

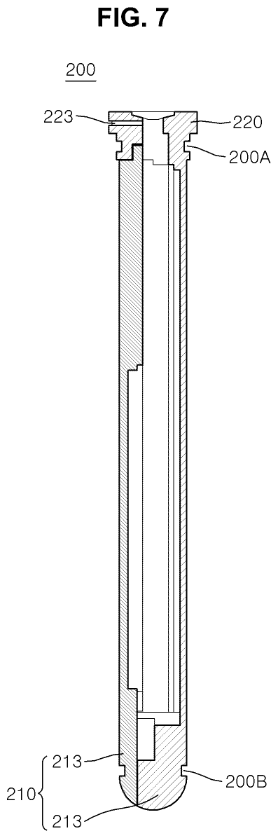

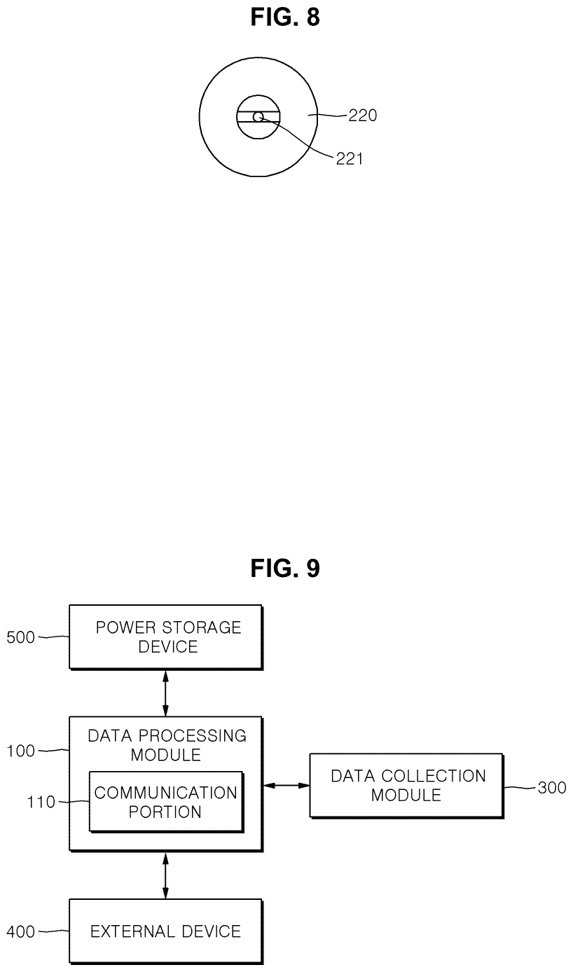

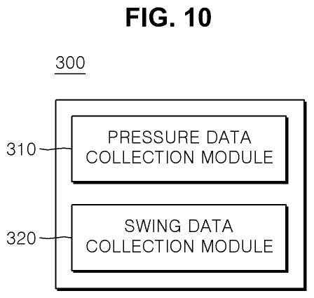

FIG. 1 is a view for describing a golf practice device according to one embodiment of the present invention. FIG. 2 is a partially-cut perspective view for describing an area that overlaps a grip portion illustrated in FIG. 1. FIG. 3 is a cross-sectional view for describing the area overlapping the grip portion that is illustrated in FIG. 2. FIG. 4 is a view for describing a pressure data collection module illustrated in FIG. 2. FIG. 5 is a perspective view for describing a capsule structure and fixing members illustrated in FIG. 2. FIG. 6 is an exploded perspective view for describing the capsule structure and the fixing members illustrated in FIG. 5. FIG. 7 is a cross-section of the capsule structure illustrated in FIG. 5. FIG. 8 is a plan view for describing a flange portion of the capsule structure. FIG. 9 is a view for describing the relationship of a data processing module, a data collection module, and an external device. FIG. 10 is a view for describing the data collection module illustrated in FIG. 9.

Referring to FIGS. 1 to 10, a golf practice device 1000 according to one embodiment of the present invention may collect and process swing data related to a swing of a golfer, who is a user, and pressure data related to a pressure with which the golfer holds a golf club. In addition, the golf practice device 1000 may send the processed data to an external device. The external device may analyze the received data and may derive methods of correcting a swing trajectory of the golfer and a way in which the golfer grips a golf club.

The golf practice device 1000 described above may include a shaft 10, a head portion 20, and a grip portion 30.

The shaft 10 may have a shape that has a predetermined diameter and extends in one direction. The head portion 20 may be connected to one side of the shaft 10, and the grip portion 30 may be connected to the other side of the shaft 10.

The shaft 10 may have the shape of a tube or a pipe. In addition, the shaft 10 may have a form in which a diameter toward the head portion 20 is smaller than a diameter toward the grip portion 30. In addition, the shaft 10 may have a form in which the diameter toward the head portion 20 and the diameter toward the grip portion 30 are the same.

The head portion 20 may be connected to the one side of the shaft 10 and may hit a golf ball through a swing of a golfer. The head portion 20 may have a form that can accurately hit a golf ball through a swing of a golfer.

The grip portion 30 is provided at the other side of the shaft 10 and allows a golfer to grip the golf practice device. The grip portion 30 may be formed of various materials that can improve a grip feeling of the golfer. For example, the grip portion 30 may be formed of a natural rubber material.

In one embodiment of the present invention, a data processing module 100, a capsule structure 200, and a data collection module 300 may be provided in an area of the shaft 10 that is adjacent to the grip portion 30. That is, the golf practice device 1000 may further include the data processing module 100, the capsule structure 200, and the data collection module 300.

The data processing module 100 may be disposed inside the shaft 10. In particular, the data processing module 100 may be mounted in an inner space of the capsule structure 200 and may be, together with the capsule structure 200, disposed in an area of the shaft 10 that overlaps the grip portion 30.

The data processing module 100 may process various data for golf practice. For example, the data processing module 100 may process swing data related to a swing of a golfer and pressure data related to a pressure with which the golfer grips the grip portion that are collected by the data collection module 300 and may generate training data according to results of processing.

The data processing module 100 may transmit the generated training data to an external device 400. To this end, the data processing module 100 may include a communication portion 110 for transmitting the data to the external device 400. That is, the data processing module 100 may be connected to the external device 400 through a wireless network. Here, the wireless network may be a connection structure in which an information exchange is possible between different nodes such as the data processing module 100 and the external device 400. Examples of such a network may include a radiofrequency (RF) network, a 3rd Generation Partnership Project (3GPP) network, a Long Term Evolution (LTE) network, a 5th Generation Partnership Project (5GPP) network, a World Interoperability for Microwave Access (WIMAX) network, the Internet, a Local Area Network (LAN), a Wireless Local Area Network (WLAN), a Wide Area Network (WAN), a Personal Area Network (PAN), a Bluetooth network, a near-field communication (NFC) network, a satellite broadcasting network, an analog broadcasting network, a Digital Multimedia Broadcasting (DMB) network, and the like, but the network is not limited thereto.

In addition, although an example in which the data processing module 100 is connected to the external device 400 through a wireless network has been described in one embodiment of the present invention, the present invention is not limited thereto. For example, the data processing module 100 may be connected to the external device 400 through a wired network. In particular, the data processing module 100 may be connected to the external device 400 through a data connection device such as a wired cable.

The data processing module 100 may store the training data. To this end, the data processing module 100 may include a memory that can store data. The memory may store the swing data and the pressure data in addition to the training data.

Meanwhile, although an example in which the data processing module 100 transmits the training data generated by processing the swing data and the pressure data to the external device 400 has been described in one embodiment of the present invention, the present invention is not limited thereto. The data processing module 100 may transmit the swing data and the pressure data to the external device 400 through the communication portion 110 without processing the swing data and the pressure data. In this case, the external device 400 may process the swing data and the pressure data and may generate training data according to results of processing.

The capsule structure 200 may be disposed inside the shaft 10. In particular, the capsule structure 200 may be disposed in the area of the shaft 10 that overlaps the grip portion 30.

The capsule structure 200 may have an inner space in which the above-described data processing module 100 can be mounted. As the data processing module 100 is mounted in the inner space of the capsule structure 200, the data processing module 100 can be disposed in the area of the shaft 10 that overlaps the grip portion 30. In addition, as the data processing module 100 is mounted in the inner space of the capsule structure 200, a change in the position of the data processing module 100 due to a swing of a golfer can be prevented.

The capsule structure 200 may have a shape that extends in one direction, for example, a direction in which the shaft 10 extends. For example, the capsule structure 200 may have the shape of a rotating body that extends in one direction.

For the data processing module 100 to be accommodated in the inner space of the capsule structure 200, the capsule structure 200 may be formed to be longer than a length of the data processing module 100. However, in order to prevent a weight increase due to the capsule structure 200 and allow the capsule structure 200 to be disposed to overlap the grip portion 30, the capsule structure 200 may be formed to be shorter than a length of the grip portion 30.

The capsule structure 200 may include a body portion 210 and a flange portion 220.

The body portion 210 may provide the inner space in which the data processing module 100 is mounted. That is, the data processing module 100 may be mounted in the inner space of the body portion 210. The body portion 210 may include a first body 211 and a second body 213.

The first body 211 may have the inner space in which the data processing module 100 is mounted, and the data processing module 100 may be mounted in the inner space.

The second body 213 may be coupled to the first body 211 and may cover the inner space of the first body 211. Therefore, the second body 213 can prevent the data processing module 100 from being exposed to the outside or falling.

The flange portion 220 may be provided at one side of the body portion 210. In addition, the flange portion 220 may be exposed to the outside of the other side of the shaft 10.

A diameter of the flange portion 220 may be larger than a diameter of the body portion 210. In addition, the diameter of the flange portion 220 may be substantially the same as an outer diameter of the shaft 10. Therefore, since the diameter of the flange portion 220 and the outer diameter of the shaft 10 are the same, an exterior of the other side of the shaft 10 may have a smooth shape.

In addition, a power terminal 221 that receives power from the outside may be provided at the flange portion 220. For example, as illustrated in FIG. 8, the power terminal 221 may be provided on an end surface of the flange portion 220.

Meanwhile, although an example in which the power terminal 221 is provided at the flange portion 220 has been described in one embodiment of the present invention, the present invention is not limited thereto. A data terminal, in addition to the power terminal 221, may be further provided at the flange portion 220. Here, the data terminal may connect the data processing module 100 and the data collection module 300 or may connect the data processing module 100 and the external device 400 through a data cable.

In one embodiment of the present invention, at least a portion of an outer portion of the capsule structure 200 may be spaced from an inner circumference of the shaft 10.

To this end, a fixing member that can separate the outer portion of the capsule structure 200 and the inner portion of the shaft 10 may be provided on at least one of both sides of the capsule structure 200. For example, a first fixing member 230 may be provided on one side of the capsule structure 200, and a second fixing member 240 may be provided on the other side of the capsule structure 200.

The first fixing member 230 and the second fixing member 240 may allow the capsule structure 200 to be fixed to the inner portion of the shaft 10 in addition to separating the outer portion of the capsule structure 200 and the inner portion of the shaft 10. In particular, the first fixing member 230 and the second fixing member 240 may separate at least an area of the capsule structure 200 that is between the first fixing member 230 and the second fixing member 240 from the inner circumference of the shaft 10.

At least one of the first fixing member 230 and the second fixing member 240 may be made of an elastic material, for example, a material such as elastic rubber. In addition, at least one of the first fixing member 230 and the second fixing member 240 may have a shape that extends along an outer circumference of the capsule structure 200. That is, at least one of the first fixing member 230 and the second fixing member 240 may serve as an O-ring.

In addition, the capsule structure 200 may include coupling grooves that allow the first fixing member 230 and the second fixing member 240 to be coupled. For example, the capsule structure 200 may include a first coupling groove 200A coupled to the first fixing member 230 and a second coupling groove 200B coupled to the second fixing member 240. The first coupling groove 200A and the second coupling groove 200B may be provided along the outer circumference of the capsule structure 200.

In one embodiment of the present invention, the golf practice device 1000 may further include a power storage device 500. The power storage device 500 may store power supplied to the data processing module 100.

The power storage device 500 may be disposed at a position that overlaps the grip portion 30. For example, the power storage device 500 may be provided in a portion of the inner space of the capsule structure 200 that overlaps the grip portion 30.

The power storage device 500 described above may be provided as a secondary battery. Therefore, the power storage device 500 may store power supplied from the outside. For example, the power storage device 500 may be electrically connected to the power terminal 221 and may store the power coming from an external power source through the power terminal 221.

Meanwhile, although an example in which the power storage device 500 is provided as a secondary battery has been described above in one embodiment of the present invention, the present invention is not limited thereto. For example, the power storage device 500 may be provided as a replaceable primary battery. Therefore, when the power stored in the power storage device 500 is used up, the power storage device 500 in which the power is used up may be separated and removed from the golf practice device 1000. Then, a new power storage device 500 in which power is stored may be coupled to the golf practice device 1000.

The data collection module 300 may collect data related to at least one of a swing of a golfer and a grip pressure on the grip portion 30. For example, the data collection module 300 may collect at least one of swing data related to a swing of a golfer and pressure data related to a grip pressure applied on the grip portion 30 by the golfer.

To this end, the data collection module 300 may include at least one of a pressure data collection module 310 and a swing data collection module 320. For example, the data collection module 300 may include only one of the pressure data collection module 310 and the swing data collection module 320 or may include both the pressure data collection module 310 and the swing data collection module 320.

The pressure data collection module 310 may generate pressure data in which a pressure applied to each point on the grip portion 30 by a golfer is transformed into numerical data and may transmit the pressure data to the data processing module 100.

The pressure data collection module 310 may be disposed to overlap the grip portion 30. For example, the pressure data collection module 310 may be disposed between the inner circumference of the grip portion 30 and the outer circumference of the shaft 10.

The pressure data collection module 310 may include a decompression film 311 and a circuit board 313.

The decompression film 311 and the circuit board 313 may be disposed between the shaft 10 and the grip portion 30 and may be provided in a stacked form. The decompression film 311 may be disposed between the shaft 10 and the grip portion 30 and may detect a pressure generated on each point of the grip portion 30.

The decompression film 311 may be a film that can detect pressure. For example, the decompression film 311 may be an ultrathin piezoresistive film such as Velostat. The decompression film 311 may be formed on an outer portion of a flexible printed circuit board (FPCB). The decompression film 311 may decrease resistance on an area where pressure is generated and may allow only a specific position on the FPCB to be conductive so that a pressure sensing signal of the specific position is transmitted.

The circuit board 313 may be disposed between the shaft 10 and the decompression film 311. The circuit board 313 may include a plurality of conductive patterns, and the conductive patterns may transmit the pressure on each point detected by the decompression film 311 to the data processing module 100. That is, the pressure data collection module 310 may detect the pressure generated on each point of the grip portion 30 to generate pressure data and may transmit the pressure data to the data processing module 100.

When the decompression film 311 detects the pressure on each point and generates pressure data, the circuit board 313 may transmit the generated pressure data to the data processing module 100.

In one embodiment of the present invention, the circuit board 313 may be provided in the form of a flexible film. For example, the circuit board 313 may be provided in the form of a FPCB.

An output terminal 313A that can send pressure data to the data processing module 100 may be provided at one side of the circuit board 313. The output terminal 313A may have a shape that extends from one side of the circuit board 313.

In one embodiment of the present invention, since the pressure data collection module 310 is provided on the outer circumference of the shaft 10, an insertion portion 223 into which the output terminal 313A is able to be inserted may be provided in a portion of the capsule structure 200. For example, the insertion portion 223 may be provided in the flange portion 220. The insertion portion 223 is a type of through-hole and may connect the inner space of the capsule structure 200 and an outer space of the capsule structure 200. Therefore, by being inserted into the insertion portion 223, the output terminal 313A may be electrically and/or physically connected to the data processing module 100.

The swing data collection module 320 may sense a swing of a golfer to generate swing data and may transmit the swing data to the data processing module 100. The swing data collection module 320 may be provided inside the shaft 10.

In one embodiment of the present invention, the swing data collection module 320 may include a sensor, such as a gyro sensor, that can detect a movement trajectory, a movement speed, an acceleration, and the like of an object.

Meanwhile, the overall weight of the golf practice device 1000 may increase due to the capsule structure 200 and the data processing module 100. In particular, a weight of an area of the golf practice device 1000 that corresponds to the grip portion 30 may increase, and the center of mass of the golf practice device 1000 may change as a result. A golfer is very sensitive to an increase in the weight of the golf practice device 1000 and a change in the center of mass thereof. Therefore, it is necessary to prevent an unintentional increase in the weight of the golf practice device 1000 and change in the center of mass thereof.

Accordingly, the grip portion 30 according to one embodiment of the present invention may have a recessed portion 31 provided in a surface facing the shaft 10 as illustrated in FIG. 3. When the grip portion 30 has the recessed portion 31, the weight of the grip portion 30 may decrease. When the weight of the grip portion 30 decreases, the weight increase due to the capsule structure 200 and the data processing module 100 and the center-of-mass change can be prevented. That is, the recessed portion 31 of the grip portion 30 may offset the weight increased due to the capsule structure 200 and the data processing module 100. Through such a weight offset mechanism, the weight of the area corresponding to the grip portion 30 may be maintained consistent before and after mounting of the capsule structure 200 and the data processing module 100 according to one embodiment of the present invention.

Although the recessed portion 31, which is one embodiment of the weight offset mechanism, has been shown in a somewhat exaggerated scale in the drawings for the sake of convenience of description, the present invention is not limited to the illustrated example, and the recessed portion may have various other structures for offsetting the weight. For example, the weight offset mechanism may be realized with a recessed embossing shape (here, the recessed embossing shape may be formed irregularly or regularly).

In addition, according to another embodiment, the weight offset mechanism may be applied using a method of adjusting the density of the grip instead of using the above-described recessed portion 31. For example, the weight offset mechanism may be applied using a method of designing the density to be lower than the density required for the grip portion itself (referred to as “standard density”). Here, the design of the density lower than the standard density may be reflected through foaming or the like in a process of manufacturing the grip portion or may be reflected through using another material with a relatively low density. Either way, it is the same that it may be considered as the weight offset mechanism for preventing an unintentional increase in the weight and change in the center of mass when adopting the capsule structure 200 and data processing module 100 to the golf practice device 1000.

Meanwhile, referring to FIGS. 8 and 9, the data processing module 100 may operate using the power stored in the power storage device 500.

In addition, the data processing module 100 may process the pressure data and the swing data collected by the pressure data collection module 310 and the swing data collection module 320 of the data collection module 300 and may generate training data.

When the training data is generated, the data processing module 100 may send the training data to the external device 400.

The external device 400 may provide the training data related to the pressure of gripping the grip portion 30 and the swing trajectory to the golfer. The golfer may check the training data and may check corrections that should be made to his or her swing, and in this way, an improvement in golfing ability can be promoted.

As described above, the golf practice device 1000 according to one embodiment of the present invention may detect at least one of swing data and pressure data of a golfer, for example, both the swing data and the pressure data of the golfer, and may generate training data by processing the swing data and the pressure data, thereby assisting in correcting the golfer's technique of gripping the grip portion 30 and swing motion.

The embodiments according to the present invention described above may be implemented in the form of program instructions that can be executed through various computer components to be recorded on a computer-readable recording medium. The computer-readable recording medium may include program instructions, data files, data structures, etc. alone or in combination. The program instructions recorded on the computer-readable recording medium may be specially designed and configured for the present invention, or may be known and available to those skilled in the art of computer software. Examples of the computer-readable recording medium include a hard disk, a floppy disk, a magnetic medium such as a magnetic tape, an optical recording medium such as CD-ROM and DVD, a magneto-optical medium such as a floptical disk, and hardware devices specially configured to store and execute program instructions, such as ROM, RAM, and flash memory. Examples of the program instructions include not only machine language codes generated by a compiler, but also high-level language codes that can be executed by a computer using an interpreter or the like. The hardware device may be modified to one or more software modules to perform processing according to the present invention, and vice versa.

The present invention is not limited to the embodiments described above, and of course, may include new embodiments in which at least two or more of the above embodiments are combined or at least one of the above embodiments and a known art are combined.

Although the present invention has been described in detail above using specific embodiments thereof, the embodiments are only for describing the present invention in detail, the present invention is not limited thereto, and it is apparent that modifications or improvements may be made by those of ordinary skill in the art within the technical spirit of the present invention.

Simple modifications or changes to the present invention all belong to the scope of the present invention, and a specific scope of protection of the present invention will become clear from the appended claims.

1-20. (canceled)

21. A golf practice device comprising:
a shaft;
a head portion provided at one side of the shaft;
a grip portion provided to surround an outer portion of the shaft at the other side of the shaft;
a data processing module disposed in the shaft to process data; and
a capsule structure having an inner space in which the data processing module is mounted and allowing the data processing module to be placed inside the shaft;
wherein the capsule structure has at least a portion spaced from an inner circumference of the shaft;
wherein the capsule structure comprises: a body portion on which the data processing module is mounted, and a flange portion provided at one side of the body portion;
wherein the golf practice device further comprises a first fixing member and a second fixing member respectively disposed at both ends of the body portion;
wherein the first fixing member and the second fixing member fix the capsule structure to an inner portion of the shaft and cause at least an area of the body portion of the capsule structure between the first fixing member and the second fixing member to be spaced from the inner circumference of the shaft;
wherein the first fixing member and the second fixing member are made of an elastic material;
wherein the body portion does not contact the shaft; and
wherein a space spaced apart between the shaft and the body portion, in an area between the first fixing member and the second fixing member, is packed with the first fixing member and the second fixing member.

22. The golf practice device of claim 21, wherein the data processing module collects at least one of swing data obtained by sensing a swing of a golfer and pressure data obtained by sensing a pressure generated by hands of the golfer.

23. The golf practice device of claim 22, wherein the capsule structure allows the data processing module to be placed at a position that overlaps the grip portion.

24. The golf practice device of claim 23, wherein the capsule structure is formed to be longer than at least a length of the data processing module and shorter than a length of the grip portion to be disposed to overlap the grip portion.

25. The golf practice device of claim 23, wherein the flange portion is provided with a power terminal that receives power from the outside.

26. The golf practice device of claim 23, wherein the flange portion is exposed to the outside of the other side of the shaft.

27. The golf practice device of claim 26, wherein the body portion comprises:
a first body having the inner space in which the data processing module is mounted; and
a second body coupled to the first body to cover the inner space.

28. The golf practice device of claim 27, wherein:
the capsule structure includes a first coupling groove and a second coupling groove in which the first fixing member and the second fixing member are respectively coupled;
the first coupling groove is provided along an outer circumference of the first body at one end of the body portion adjacent to the flange portion; and
the second coupling groove is provided along an outer circumference of the first body and the second body at the other end of the body portion.

29. The golf practice device of claim 26, wherein the flange portion has an outer diameter that is substantially the same as an outer diameter of the other side of the shaft.

30. The golf practice device of claim 23, wherein the grip portion includes a weight offset mechanism that reduces a weight of the grip portion to offset a weight increased due to the capsule structure and the data processing module.

31. The golf practice device of claim 30, wherein the grip portion has a recessed portion provided in a surface facing the shaft, and the recessed portion reduces the weight of the grip portion and offsets the weight increased due to the capsule structure and the data processing module.

32. The golf practice device of claim 23, further comprising a power storage device storing power supplied to the data processing module, wherein the power storage device is disposed to overlap the grip portion.

33. The golf practice device of claim 26, further comprising a data collection module including at least one of a pressure data collection module collecting pressure data and a swing data collection module generating swing data by sensing a swing of the golfer;
wherein the pressure data collection module comprises:
a decompression film provided between the shaft and the grip portion, and
a circuit board electrically connected to the data processing module; and
wherein the pressure data collection module detects a pressure generated on the grip portion to generate the pressure data and transmits the pressure data to the data processing module.

34. The golf practice device of claim 33, wherein:
an output terminal sending the pressure data to the data processing module is provided at one side of the circuit board;
an insertion portion into which the output terminal is inserted is provided in a portion of the body portion; and
the insertion portion connects the inner space of the capsule structure and an outer space thereof.

35. The golf practice device of claim 34, wherein the insertion portion is provided in the flange portion.

36. The golf practice device of claim 35, wherein the data processing module processes the data and generates training data, and a communication portion provided at the data processing module transmits the training data to an external device through wireless communication.

37. The golf practice device of claim 35, wherein a communication portion provided at the data processing module transmits the data to an external device, and the external device processes the data and generates training data.
